(19) United States
(12) Patent Application Publication
(10) Pub. No.: US 2010/0126630 A1
(43) Pub. Date: May 27, 2010

(54) METHOD OF PRODUCING FLAT CHIPS OUT OF WOOD

(76) Inventor: Robert Loth, Lage-Müssen (DE)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 12/449,130

(22) PCT Filed: Jan. 25, 2008
(86) PCT No.: PCT/EP2008/000563

§ 371 Date: Jan. 8, 2010

(30) Foreign Application Priority Data
Jan. 25, 2007 (DE) 10 2007 003 698.3

(51) Int. Cl. B27L 11/00

(52) U.S. Cl. 144/373

(57) ABSTRACT

The invention relates to a method of producing flat chips for structurally-oriented wood materials.

The method comprises the following method steps:
an intermediate product is generated from lignocelluose-containing material;
the intermediate product is of a length between 20 and 200 mm;
the intermediate product undergoes a hydrothermal treatment;
the period of action lasts at least three minutes, while the temperature of action is at least 40° C.;
the intermediate product undergoes chipping or splitting.

The invention relates to a method of producing flat chips out of wood, also designated as “OS chips” (“oriented strand”).

Structurally-oriented wood materials involve special lignocellulose-containing boards or molded articles that have oriented mechanical and hygric properties. Included among these wood material are LSL, PSL, and especially OSB. OSB is the structurally-oriented wood material of greatest economic significance. Due to the shape and size of the strands, the corresponding wood materials provide strong mechanical properties. As a result, they can be applied in particular as construction components in the construction industry.

U.S. Pat. No. 2,874,909A discloses a method for generating chips for fabricating boards and comprising the following method steps: an intermediate product is generated from fresh wood or recycled wood; the intermediate product is essentially bar-shaped; the intermediate product is fed to a chipper comprising a plurality of knives that are disposed on a knife ring, the blades of which run at least approximately parallel to the ring axis and which enclose a working space; the intermediate product is caused to revolve about the axis of the knife ring and thereby aligned such that it is oriented essentially parallel to the ring axis and is pressed against the blades of the knives by centrifugal force; the intermediate product measures several centimeters in length.

DE 11 71 143 B illustrates and describes the effect of heat, moisture, and pressure during the production of chips for the purpose of improving their quality.

A successful method for producing OS chips is described in EP 1 335 818 B1. Here the shape of the intermediate product is defined more precisely.

The method is capable of being improved, however. This mainly relates to the quality of the individual flat chip. The flat chip should if possible be of even higher quality in terms of its shape and its surface. In addition, the chipping process should produce the maximum in terms of high-quality flat chips but the minimum in terms of the fraction of fine material. Finally, the energy requirement should be minimized.

The fundamental problem to be solved by the invention is to provide a method by which a strand material composed of small-piece-type wood components (intermediate products such as Maxichips and flat chips) can be produced, which contains large fractions of distinctly laminar strands and small fractions of fine material. In addition, the energy for chipping should be minimized.

This problem is solved by the features of claim 1.

The fundamental ideas of the invention relate to the shape of the intermediate product and to providing an additional treatment step: Specifically, the intermediate product undergoes an intermediate treatment comprising the action of heat and moisture before it is further treated mechanically.

The referenced treatment with moisture and heat is applied to the intermediate product (Maxichip) after shredding. The treatment can be combined with the application of hyperbaric pressure.

Any heat sources can be used to effect the treatment with heat, such as, for example, microwave or infrared devices. A hot-water treatment or steam treatment can also be considered.

The entire method can be implemented batchwise or continuously. In the continuous process, use of worm conveyors is conceivable. This worm conveyor can be charged with a woodchip-water mixture. Pressure can be generated by a shut-off valve opening a restricted discharge slit at the end of the feed screw, thereby building up pressure within the feed screw. A steam treatment can also take place within the feed screw. Low pressure or excess pressure can also be applied.

The results are amazing. Specifically, the process according to the invention has the following advantages:
the chipping process yields a high fraction of flat chips and a minimum fraction of unwanted fine material:
the quality of the flat chips is better than those generated previously: the chips have a flawless surface suitable for generating OS board; the chips furthermore exhibit a higher strength than previously;
due to the hydrothermal treatment and less-damaging chipping, the strands furthermore exhibit fewer cracks; the risk of secondary shredding by subsequent processes during fabrication of the OSB is thus reduced;
the specific energy cost in kWh relative to quantity unity of generated OS chips is significantly lower than with known methods;
in terms of primary material, any lignocellulose-containing materials can be considered—thus, wood, waste wood, shredded wood, recycled wood, but also exotic materials such as bamboo, palms.

The following discussion describes the invention in more detail based on the drawing. In the drawing specifically:

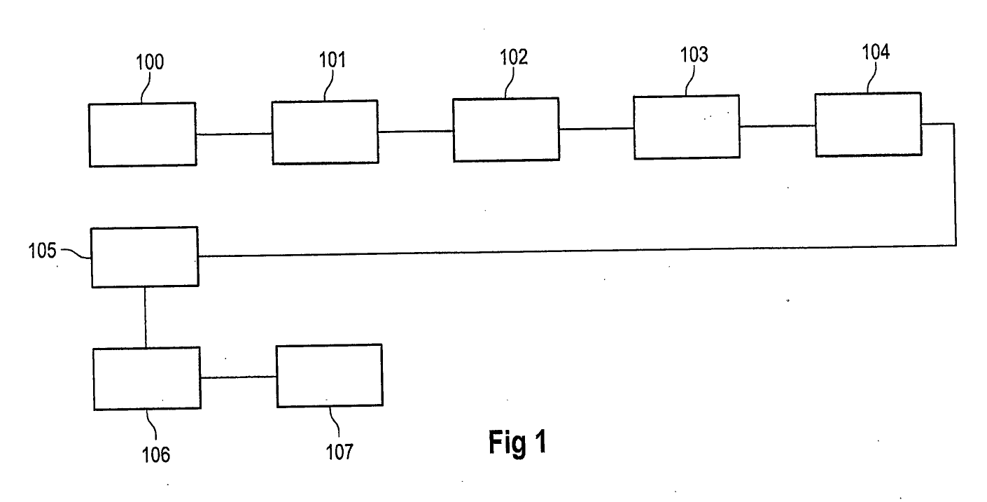

FIG. 1 shows a block diagram to illustrate the operational process of a method for fabricating OS board.

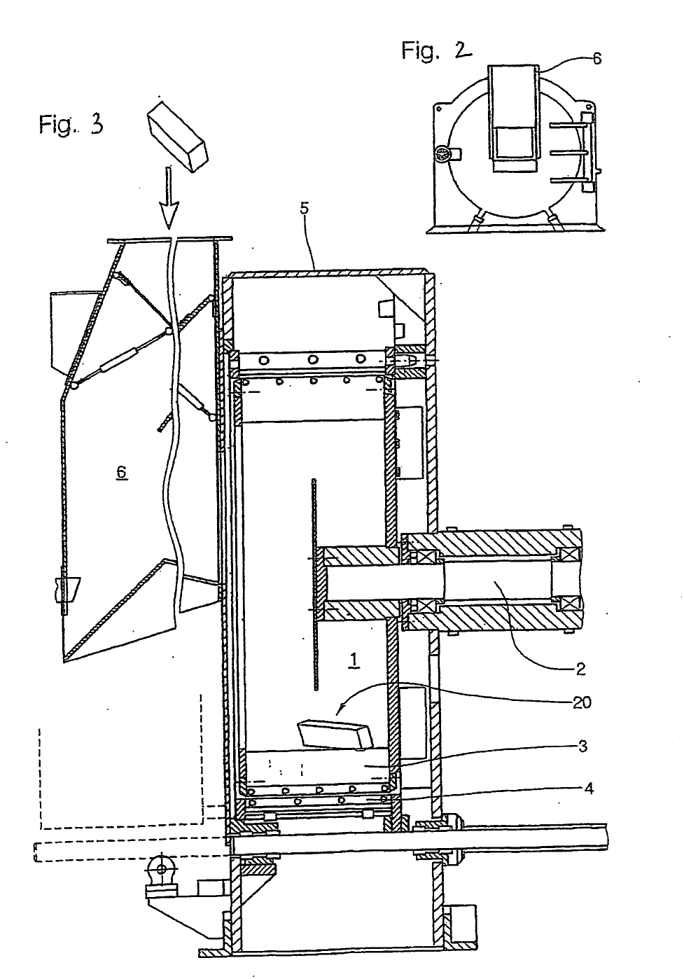

FIG. 2 shows a front view of a chipper, that is, a view towards the side on which the housing cover with insert for the intermediate product is located.

FIG. 3 illustrates an axial section through the chipper of FIG. 2 on an enlarged scale.

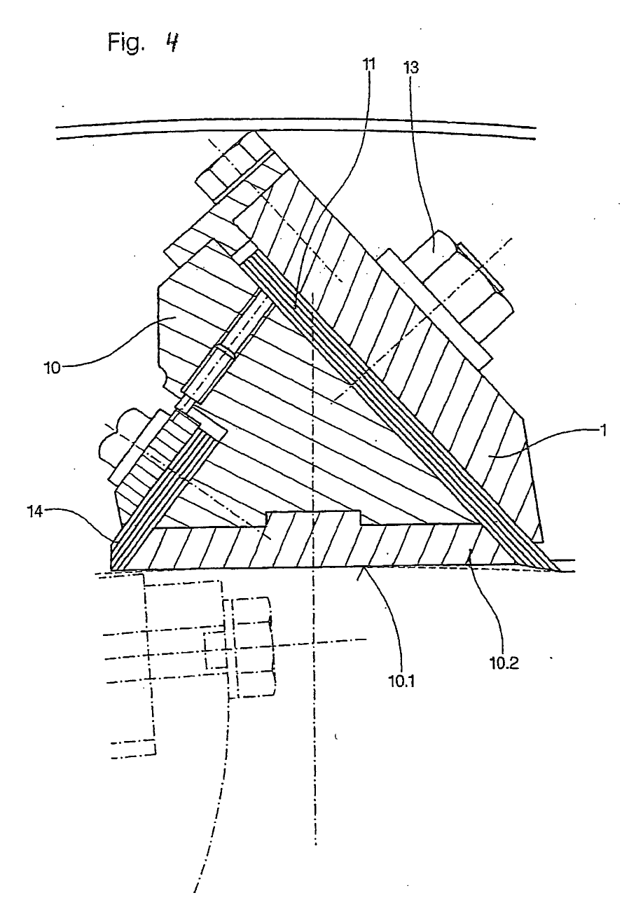

FIG. 4 shows an enlarged diagram illustrating a section from FIG. 3, specifically, a knife assembly.

The block diagram of FIG. 1 shows the following stations of the method for producing OS board:

The material to be processed is first stored in station 100. In terms of this example, these can be used wood pallets. Obviously, all possible other lignocelluose-containing materials can be considered, as was mentioned above.

Rough pre-shredding occurs in station 101—for example, in a shredder.

Shredding occurs in station 102. The intermediate product is generated here. This is at least approximately bar-shaped.

A treatment with moisture and heat occurs in station 103. Treatment can consist of immersion in hot water. The water is at a temperature of more than 50° C.—for example, 60, 70, 80, 90, 100° C. The residence time ranges between 3 and 30 minutes. Even longer time periods can be considered—for example, one hour, two hours, etc.

Scalding with superheated steam can also be considered in place of immersion in hot water.

The wet-hot treatment can also take place under hyperbaric pressure or subatmospheric pressure, thus in a closed vessel. Here the intermediate product—and thus the wood chips—are completely penetrated by moisture. A certain level of plastification takes place, in some cases a solubilization of the lignin.

The intermediate product is pre-screened at station 104.

Chipping takes place at station 105. The result is OS chips having a chip thickness ranging between 0.2 and 0.8 mm, at best 0.2 to 0.6 mm.

After chipping, post-screening takes place at station 106.

This is followed by subsequent processing into OS board at station 107.

As seen in FIGS. 2 and 3 in detail, the chipper comprises a rotor 1 that is driven by a shaft 2. Rotor 1 contains a ring of axially-parallel vanes 3. A knife box also with knives 4 disposed in axially-parallel fashion surrounds rotor 1. Rotor 1 and knife box are in turn disposed in a housing 5 and together enclosed by this housing. Housing 5 has an inlet 6 for the wood chips to be supplied and an outlet for the finished chips.

FIG. 3 illustrates a bar-shaped intermediate product 20 at two positions. In the present case, this has been prepared in the form of regular rectangular blocks. This intermediate product could also have a different shape instead, however—for example, have irregular peripheral surfaces. The only critical aspect is that this intermediate product 20 is more or less bar-shaped, that is, it has a longitudinal section that is greater than the transverse section in planes running perpendicular thereto.

The intermediate product 20 is fed into shaft-like inlet 6—see arrow. It then moves into the interior space surrounded by rotor 1. Here, intermediate product 20 comes to be oriented—either automatically or by an appropriate orientation device—such that it runs predominantly parallel to the longitudinal axis of rotor shaft 2, and thus more or less parallel to knives 4. The intermediate product is of considerable size, in particular, of considerable length when compared with wood pieces of this type that have previously been fed to knife-ring chippers.

FIG. 4 illustrates an axially-perpendicular section through a knife assembly. Each knife assembly is a component of the knife ring of the machine.

Each knife assembly is constructed as follows: A support block 10 supports a cutting knife 11 that is affixed to support block 10 by a clamping plate 12 and a screw 13.

Each support block 10 has a wear surface 10.1. The critical aspect is that this wear surface 10.1 facing the machine axis is approximately flat and thus not concentric as in the prior art.

Here wear surface 10.1 is composed, as in FIG. 4, of a wear plate 10.2 that is in turn affixed on the rest of support block 10. The wear surface can also be composed of a wear layer that has been generated by applying a wear layer, preferably by build-up welding or spraying on, followed by grinding.

In the embodiment of FIG. 4, a bed knife 14 is provided, which is attached on the side of support block 10 opposite cutting knife 11 and that works together with the cutting knife of the adjacent knife assembly. A wear plate is also conceivable in which the bed knife is integrated and assumes the function thereof.

### LIST OF REFERENCE NUMBERS

1 rotor
2 shaft
3 vane
4 knife
5 housing
6 inlet
10 support block
10.1 wear surface
10.2 wear plate
11 cutting knife
12 clamping plate
13 screw
14 bed knife
20 intermediate product
100 storage station for waste wood
101 rough shredding station
102 shredding station
103 hot water station
104 pre-screening station
105 chipping station
106 post-screening station
107 subsequent processing

1. A method for producing flat chips for structurally-oriented wood materials, the method comprising following method steps:
generating an intermediate product from lignocelluose-containing material;
treating said intermediate product using a hydrothermal treatment; and
treating said intermediate product using a chipping process or a splitting process;
wherein said intermediate product is of a length ranging from between 20 mm and 200 mm and the hydrothermal treatment lasts for at least three minutes at a temperature of at least 40° C.

2. The method according to claim 1, further comprising applying during the hydrothermal treatment one or more of dry heat, steam, hot water, a water bath, a microwave treatment or a high-frequency treatment.

3. The method according to claim 1 wherein the hydrothermal treatment of the intermediate product takes place before the chipping process or the splitting process or during the chipping process or splitting process.

4. The method according to one of claim 1 wherein the intermediate product has a moisture content of more than 35% absolutely dry after the hydrothermal treatment.

5. The method according to one of claim 1 wherein the hydrothermal treatment is effected at hyperbaric pressure or subatmospheric pressure.

6. The method according to one of claim 1 wherein the chipping process of the intermediate product is effected in knife ring chippers, knife shaft chippers, or disk chippers.

7. The method according to claim 6, further comprising:
feeding the intermediate product into a chipper, comprising a plurality of knives that are disposed on a knife ring, the blades of which run at least approximately parallel to the ring axis and enclose a working space;
rotating the intermediate product about the knife ring axis in such a way that the product is oriented essentially parallel to the ring axis and is pressed by centrifugal force against the blades of the knives;
screening said intermediate product on the upstream side of the chipping process to allow only intermediate product of a specified size to pass through; and
classifying said intermediate product on the downstream side of the chipping process to classify the chips according to criteria based on their shape or their dimensions or their weight;
wherein the operating parameters, such as knife shape, knife angle, are selected such that the resulting flat chips have a chip thickness of 0.2 to 0.8 mm, preferably, 0.2 to 0.6 mm.
